(19) United States
(12) Patent Application Publication
(10) Pub. No.: US 2008/0005860 A1
(43) Pub. Date: Jan. 10, 2008

(54) BRUSH BRISTLE MATERIAL AND BRUSH

(75) Inventors: Yuuichiro Niizaki, Chigasaki-shi (JP); Tomoko Niizaki, Chigasaki-shi (JP); Yunito Niizaki, Chigasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignees: Yuuichiro NIIZAKI, Chigasaki-shi (JP); Tomoko NIIZAKI, Chigasaki-shi (JP)

(21) Appl. No.: 11/773,722

(22) Filed: Jul. 5, 2007

(30) Foreign Application Priority Data
Jul. 7, 2006 (JP) 2006-187373

(51) Int. Cl. A46D 1/00; B32B 9/00

(52) U.S. Cl. 15/207.2; 428/368

(57) ABSTRACT

A brush bristle material has at least one kind of diamond abrasive grains or abrading grains contained in a mixed state in a synthetic resin material formed of single threads. The synthetic resin material, while being formed into a linear material from chips, is caused to contain in a mixed state the abrasive grains and eventually manufactured into one brush. A plurality of at least one kind of brush bristles are bundled and consequently finished as a brush bristle material. The covering containing in a mixed state the abrasive grains encloses the bundle from the part excluding the part fixed by the tubular body through the distal end part. Though the brush bristle material has been at a disadvantage in revealing weak nerve due to a large bristle height, the covering has succeeded in canceling the disadvantage. This invention concerns a brush bristle material and a brush for a tubular brush or a segment brush having a large brush bristle height.

### BACKGROUND OF THE INVENTION

1. Field of the Invention

This invention relates to a brush bristle material for a tubular brush having a large brush bristle length or for a segment brush. This invention relates to a brush bristle material that manifests strong nerve even when the bristle height is large, avoids being spread while in service and allows enhancement of abrading force or honing force and to a brush made of the brush bristle material.

2. Description of the Prior Art

FIG. 7(a) to FIG. 7(c) are schematic views intended for the explanation of a tubular brush bristle material belonging in the conventional type. Referring to FIG. 7(a), the tubular brush has a brush bristle material 72 attached to a tubular body 71. The brush bristle material 72 in the tubular brush in most cases has a large bristle height. While the brush is being used, therefore, the brush bristle material 72 possibly spreads as shown in FIG. 7(b) and suffers the part thereof other than the distal end part to fulfill the role of grinding. The tubular brush shown in FIG. 7(c) at times necessitates use of an adhesive agent 74 for the purpose of preventing the brush bristle material 72 from spreading.

The brush disclosed in JP-A 2003-164332 is manufactured by a procedure that comprises nipping metal wires among three metal wire materials and twisting them together. In the twisted part of the brush, a hollow pipe made of metal is inserted and fixed in the inserted state by a drawing work performed on the perimeter.

Then, the brush disclosed in JP-A 2002-254277 causes an aggregate yarn formed of a plurality of alumina filaments to be cured and bundled through impregnation with a binder resin. The plurality of alumina filaments are enabled to grind burrs, etc. by utilizing the free ends thereof which have not been cured owing to the adhesion of the binder resin.

The brush bristle material of the conventional tubular brush with a large bristle height has incurred difficulty in performing proper grinding accurately because the distal end part of the brush bristle is eventually spread with use and the lateral face of the brush bristle is compelled to perform the work of grinding. For preventing the brush bristle from being spread in the distal end part thereof means, such as for coiling a wire around the lateral surface of the brush bristle, covering the brush bristle with a tube or a pipe, and fastening the brush bristle with adhesive agent have been adopted. The means for preventing the spread have entailed many problems, such as various troubles mentioned above, inferior workability and uneven finish of grinding. The plan to stop the spread with adhesive agent incurs the problem that the adhesive agent is caused by the frictional heat during the course of grinding to emit offensive odor and stimulate the eyes and the nose of an operator.

With a view to solving the problems mentioned above, this invention is aimed at providing a tubular brush bristle material and a brush that are capable of enforcing the part of nerve and enhancing the abrading force or honing force, thereby preventing the distal end part from being spread in spite of an addition to the bristle height. This invention is also aimed at providing a brush bristle material and a brush that are capable of preventing the accident that takes place when the brush bristle material is broken and scattered.

### SUMMARY OF THE INVENTION

The brush bristle material of the first aspect of the invention comprises a brush bristle material having bundled a plurality of one or more kinds of brush bristles obtained by causing a synthetic resin material formed of single threads to contain in a mixed state one or more kinds of diamond abrasive grains or abrading grains, a metallic fitting enabled to admit insertion of the proximal end part of the bundled brush bristle material and to fix the proximal end part, and a covering containing abrasive grains in a mixed state and serving to cover the brush bristles from the part thereof excluding the proximal end part fixed by the metallic fitting to the distal end part thereof.

The brush bristle material of the second aspect of the invention comprises a brush bristle material having bundled a plurality of one or more kinds of brush bristles obtained by causing the perimeter of a metallic material formed of single threads to be clad with one or more kinds of diamond abrasive grains or abrading grains, a metallic fitting enabled to admit insertion of the proximal end part of the bundled brush bristle material and to fix the proximal end part, and a covering containing abrasive grains in a mixed state and serving to cover the brush bristles from the part thereof excluding the proximal end part fixed by the metallic fitting to the distal end part thereof

In the brush bristle material of the third aspect of the invention, the covering of the first or second aspect of the invention is any material selected from among a string member, a network member, a plated member, a vapor-deposited member, a coating member, a pipe made of synthetic resin and a pipe made of metal which are invariably wound around the perimeter of the brush bristle material.

In the brush bristle material of the fourth aspect of the invention, the synthetic resin material of the first or third aspect of the invention contains in a mixed state one or more kinds of diamond abrasive grains, honing abrasive grains, charcoal, volcanic ash, negative ion material and flavor material at a ratio in the range of 1% to 50%.

In the brush bristle material of the fifth aspect of the invention, the metallic material of the second aspect of the invention has attached to the perimeter thereof one or more kinds of diamond abrasive grains and honing abrasive grains by electrodeposition, adhesive agent or plating treatment at a ratio in the range of 1% to 100%.

In the brush bristle material of the sixth aspect of the invention, the brush bristle material in any of the first to fifth aspects of the invention comprises a plurality of brush bristle materials bundled into a bundle and the covering covers the perimeter of the bundle.

In the brush bristle material of the seventh aspect of the invention, the brush bristle material in any of the first to sixth aspects of the invention comprises a plurality of different kinds of brush bristle materials bundled into a bundle and the covering covers the perimeter of the bundle.

In the brush bristle material of the eighth aspect of the invention, the brush bristle material in any of the first to sixth aspects of the invention comprises a plurality of brush bristle materials bundled into a bundle and the covering covers the perimeter of the bundle.

A brush comprising the brush bristle material in any of the first to eighth aspects of the invention is formed into a channel brush, an implanted brush or a welded brush and fated to serve as a roll brush, a wheel brush, a coiled brush, a tubular brush or a twisted brush.

This invention, by fixing one end of a bundle comprising a plurality of brush bristle materials with a tubular body and as well covering the part of the bundle extending to the other end, is enabled to obtain a brush bristle material possessing strong nerve even when the brush bristle material having a long height.

This invention, by applying abrasive grains and/or honing abrasive grains or powders thereof in an optionally varied combination and/or quantity to a synthetic resin material and a metallic material through insertion, inclusion, cladding, electrodeposition, vapor deposition, plating treatment, coating or covering, is enabled to obtain a brush bristle material and a brush that are endowed with a wide range of abrasive properties.

This invention allows varying combinations of the brush bristle materials to be further bundled. It also allows a plurality of such bundles of brush bristle materials to be further bundled. This invention is thus enabled to obtain a brush bristle material and a brush that are capable of performing abrasion suited to the performance of a given workpiece.

The above and other objects, characteristic features and advantages of the present invention will become apparent to those skilled in the art from the description to be made herein below with reference to the accompanying drawings.

### BRIEF DESCRIPTION OF THE DRAWINGS

FIG. 1(a) to FIG. 1(d) depict Example 1 of this invention in cross sections for explaining brush bristle materials furnished with coverings of synthetic resin material and/or metallic material.

FIG. 2(a) to FIG. 2(l) depict Example 2 of this invention in cross sections each for explaining brush bristle materials having contained in a mixed state diamond abrasive grains, metallic abrasive grains, rock abrasive grains, etc. and their shapes.

FIG. 3(a) to FIG. 3(d) depict Example 3 of this invention in a front view and a cross section for illustrating the manufacture of tubular brushes from brush bristle materials embodying this invention.

FIG. 4 depicts Example 4 of this invention in a perspective view for explaining the attachment of a tubular body and a brush bristle material.

FIG. 5(a) and FIG. 5(b) depict Example 5 of this invention in front views for explaining brushes adapted to facilitate attachment of a tubular body to a grinding device.

FIG. 6(a) to FIG. 6(h) depict Example 6 of this invention in schematic views for illustrating the production of brushes using brush bristle materials conforming to this invention.

FIG. 7(a) to FIG. 7(c) are schematic view for explaining the conventional tubular brush bristle materials.

### DETAILED DESCRIPTION OF THE PREFERRED EMBODIMENTS

The brush bristle material of the first aspect of the invention has one or more kinds of diamond abrasive grains or abrading grains contained in a mixed state in a synthetic resin material formed of single threads. The synthetic resin material, while being formed into a wire rod from chips, is caused to contain in a mixed state the abrasive grains and finished as one brush bristle. A plurality of one or more kinds of such brush bristles are bundled or interwoven and eventually finished as a brush bristle material. The proximal end part of the bundle of brush bristle materials is fixed by being inserted into a tubular body or a bag member. The covering that has included the abrasive grains envelopes the bundle from the part excluding the proximal end part fixed by the tubular body or the bag member to the distal end part thereof Though the brush bristle material is at a disadvantage in revealing weak nerve due to the largeness of bristle height, the covering succeeds in depriving this brush bristle material of the disadvantage.

The synthetic resin material is made of heat-resistant fibers of polyamide resin, polypropylene, polyethylene, polyvinyl chloride, polyimide, polymer, polyester, polyplastics, PolyEtherEtherKetone (PEEK™) resin and aromatic polyamide, for example. Particularly, the synthetic resin material, by containing in a mixed state animal bristles (horse bristle, pig bristle, etc.) and/or vegetable fibers (pakin (tampico), palm, banana, etc.), is enabled to be manufactured into one brush bristle material.

The brush bristle material of the second aspect of the invention differs from that of the first aspect of the invention in using metallic material instead of the synthetic resin material and as well having the brush bristle of the metallic material covered with abrasive grains in such a manner as is coated therewith. The metallic material is of iron, copper, aluminum, titanium, nickel, chromium or an alloy thereof, for example. The metallic material is coated on the perimeter thereof with the abrasive grains by electrodeposition, vapor deposition, thermal welding, plating or the like.

The brush bristle material of the third aspect of the invention uses as what corresponds to the covering of the first invention or the second invention any member selected from among the string member, network member, plated member, vacuum-deposited member, coating member, pipe made of synthetic resin and pipe made of metal that are invariably adapted to be coiled around the brush bristle material. Since the covering serves to cover the waist part of the brush bristle material, the brush bristle material is enabled to acquire strong nerve even when the bristle is given a large height.

The brush bristle material of the fourth aspect of the invention has the synthetic resin material of the first or third aspect of the invention contain in a mixed state one or more kinds of diamond abrasive grains, honing abrasive grains, charcoal, negative ion material and flavor material or the powder thereof in a volume ratio in the range of 1% to 50%. The synthetic resin material, while being manufactured into a brush bristle material of a prescribed shape from chips, is formed after it has included the abrasive grains or the powders thereof The abrasive grains or powders thereof may be similarly included into fibers made of synthetic resin besides the tubular body or the bag body and consequently enabled to produce the cord or the net of the second aspect of the invention.

The metallic material of the fifth aspect of the invention has attached to the perimeter thereof one or more kinds of diamond abrasive grains and abrading grains through electrodeposition, vapor deposition, thermal welding, or plating treatment at a ratio in the range of 1% to 100%. The abrasive grains are of diamond abrasive grains, inorganic abrasive grains, metal or alloy abrasive grains, volcanic ash abrasive grains, obsidian abrasive grains, lava abrasive grains or basalt abrasive grains. The coating is capable of attachment of various abrasive grains at a ratio in the range of 1% to 100%. Since the amount (thickness) of the coating can be optionally set, it is made possible to easily adapt the strength of nerve for the purpose or the shape, impart more elastic force to the synthetic resin material and prevent the metallic material from being broken. Incidentally, the coating at a ratio in the range of 1% to 10% on balance equals the state in which the attachment takes place on the perimeter of the metallic material.

The brush bristle material of the sixth aspect of the invention is obtained at least solely by bundling a plurality of brush bristle materials of the first to fifth aspects of the invention and subjecting the perimeter of the resultant bundle of brush bristle materials to covering, interweaving or coating. The brush bristle material of the sixth aspect of the invention may be obtained as a brush bristle material suited to the surface of a given workpiece by selecting the raw material for brush bristle material, the number of brush bristle materials and the number of brush bristle materials to be bundled.

The brush bristle material of the seventh aspect of the invention is obtained by bundling a plurality of different kinds of brush bristle materials of the first to sixth aspects of the invention. A plurality of the same or different brush bristle materials severally obtained by the bundling are bundled and the perimeter of the resultant bundle is subjected to covering, interweaving or coating. The brush bristle material of the seventh aspect of the invention may be adapted to suit a wider range of applications than the brush bristle material of the sixth aspect of the invention by optionally selecting different brush bristle materials.

The brush bristle material of the eighth aspect of the invention is obtained at least solely by bundling a plurality of brush bristle materials of the sixth and seventh aspects of the invention and subsequently subjecting the perimeter of the resultant bundle of brush bristle materials to covering, interweaving or coating. The kinds of the brush bristle materials of the sixth and seventh aspects of the invention can be selected and the number of these brush bristle materials to be bundled can be decided with the object of obtaining proper strength suited to the grinding of a given workpiece.

The brush of the ninth aspect of the invention is obtained as a channel brush, an implanted brush, a welded brush and the like by having the brush bristle materials of the first to eighth aspects of the invention embedded in a channel member or a deck member and straightening up the products of embedment. The various brushes are formed in proper shapes and consequently finished as a roll brush, a wheel brush, a coiled brush, a tubular brush and a twisted brush, which possess optimum shape, strength and elastic force for grinding a given workpiece.

### EXAMPLE 1

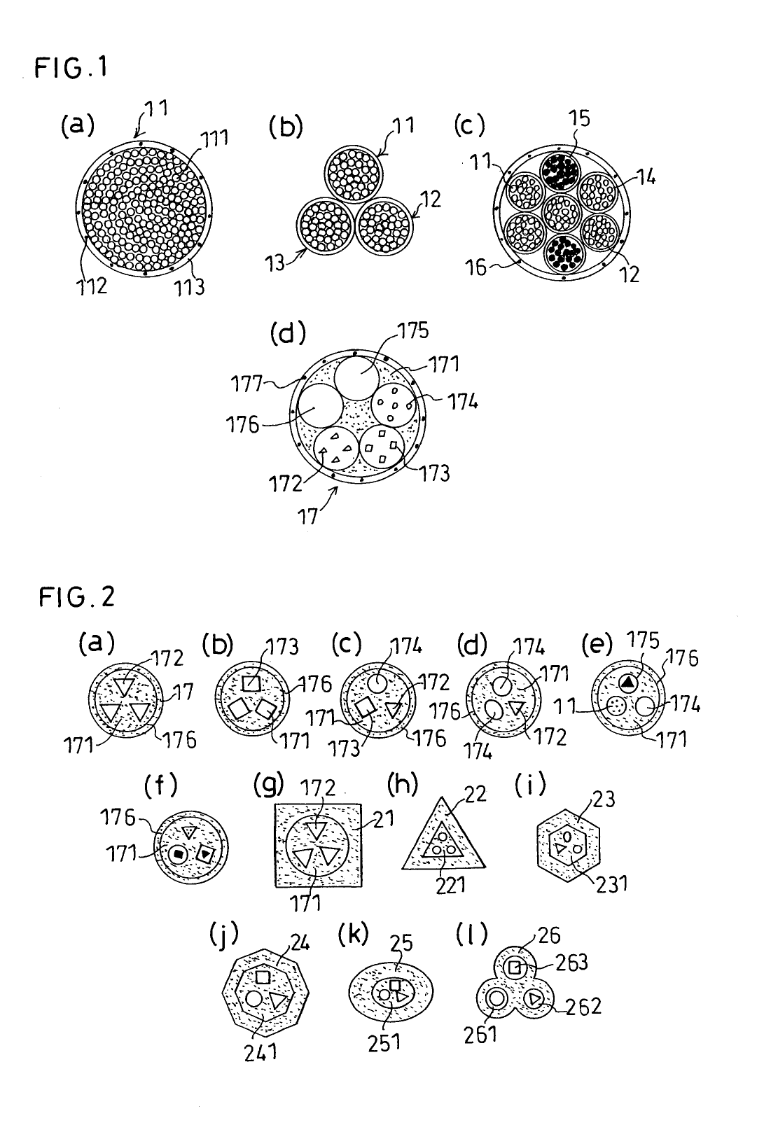

FIG. 1(a) to FIG. 1(d) depict Example 1 of this invention in cross sections for illustrating brush bristle materials that use coverings of synthetic resin material and/or metallic material. The brush bristle material 11 shown in FIG. 1(a) is obtained by bundling a plurality of fibers 111 of synthetic resin approximately measuring 0.02 mm to 0.03 mm in diameter and applying a covering 113 to the perimeter of the resultant bundle. The covering 113 is either obtained by twining a plurality (five, for example) of cords measuring about 0.6 mm in diameter and using the same fibers of synthetic resin as mentioned above or formed of a net using such cords.

The covering 113, when being obtained by using the cords of synthetic resin fibers, is coiled around the perimeter of the brush bristle material. The fibers constituting either the covering 113 or the brush bristle material 11 contain diamond abrasive grains, inorganic abrasive grains, metallic abrasive grains or other publicly known abrasive grains. The fibers constituting the brush bristle material are each obtained by heating chips of synthetic resin to a prescribed temperature and passing the resultant melt through a die. The fibers in the course of this procedure are caused to include the powders of the abrasive grains. The brush bristle using a metallic wire is manufactured by applying the powders of the abrasive grains to the perimeter of the metallic wire through electrodeposition, vapor deposition, thermal welding, plating or coating.

The fibers made of the synthetic resin are heat-resistant fibers of polyamide-based resin, polypropylene, polyethylene, polyvinyl chloride, polyimide, polymer, polyester, polyplastics, PEEK™ resin and aromatic polyamide. Particularly, the synthetic resin material, by containing in a mixed state animal fibers (horse bristle, pig bristle and the like) and/or vegetable fibers (pakin (tampico), palm, banana, etc.), can be manufactured into one brush bristle material. Then, the metallic material is of iron, copper, aluminum, titanium, nickel, chromium and alloys thereof The coating of the perimeter of the metallic material is accomplished by electrodeposition or plating, for example.

The brush bristle material shown in FIG. 1(b) is obtained by bundling the three brush bristle materials 11, 12 and 13 shown in FIG. 1(a). The brush bristle material shown in FIG. 1(c) is obtained by further bundling the brush bristle materials 11 and 12 resulting from bundling the fibers of synthetic resin shown in FIG. 1(a) with the covering 113, a brush bristle material 14 having metallic abrasive grains applied to the perimeter by coating and a brush bristle material 15 resulting from bundling and covering metallic wires and subsequently enclosing the resultant bundle with the covering 16 having contained in a mixed state the abrasive grains or powders thereof.

The brush bristle material 17 shown in FIG. 1(d) has diamond abrasive grains 172, metallic abrasive grains 173, lava abrasive grains (basalt grains) 174 and other abrasive grains 175 and 176 contained in fibers made of synthetic resin (member made of synthetic resin) 171. The abrasive grains or the powders thereof are included in the fibers while the member of synthetic resin is being manufactured by heating the chips of the synthetic resin.

### EXAMPLE 2

FIG. 2(a) to FIG. 2(l) depict Example 2 of this invention in cross sections for explaining brush bristle materials containing in a mixed state diamond abrasive grains, metallic abrasive grains, rock abrasive grains, etc. and their shapes. The brush bristle materials shown in FIG. 2(a) to FIG. 2(f) are examples having at least one of the same or different kinds of abrasive grains 172, 173, 174 and 175 contained in a mixed state in the member of synthetic resin 171. The coverings of the brush bristle materials shown in FIG. 2(a) to FIG. 2(f) contain one or more kinds of the abrasive grains 176.

The brush bristle materials shown in FIG. 2(g) to FIG. 2(l) have coverings 21, 22, 23, 24, 25 and 26 severally differ in shape. The shapes of the coverings and the kinds of abrasive grains contained therein may be optionally selected to suit the shape, hardness and object of grinding of a given workpiece.

### EXAMPLE 3

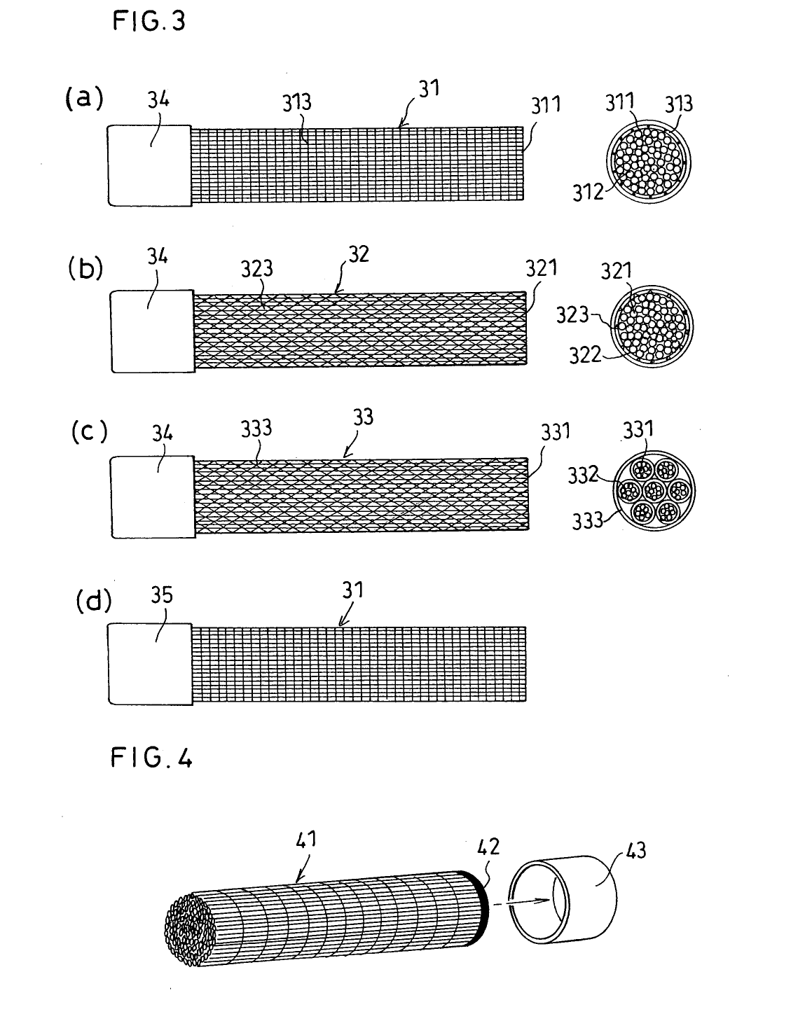

FIG. 3(a) to FIG. 3(d) severally depict Example 3 of this invention in a front view and a cross section for explaining the tubular brushes manufactured from brush bristle materials embodying this invention. The tubular brush 31 shown in FIG. 3(a) forms on the perimeter of a covering 312 for a brush bristle material 311 made of metal or synthetic resin a covering 313 that results from coiling a cord made of metal or fibers around the perimeter. The tubular brush 32 shown in FIG. 3(b) forms on the perimeter of a covering 322 for a brush bristle material 321 made of metal or synthetic resin a covering 323 that results from encasing the perimeter with a net made of metal or fibers.

Similarly, the tubular brush 33 shown in FIG. 3(c) forms on the perimeter of a brush bristle material 331 made of metal or synthetic resin a covering 333 that results from coating the perimeter with a net formed of metal or fibers. The tubular brush 33 is composed of a plurality of covered brush bristle materials 332 inside the covering 333. The covered brush bristle materials 31 to 33 shown in FIG. 3(a) through FIG. 3(d) severally have their respective one ends fixed by being inserted in tubular bodies 34 and 35 made of metal. The metallic tubular bodies 34 and 35 are detachably attached in a plural form to an electromagnet provided for a grinding device, for example.

### EXAMPLE 4

FIG. 4 depicts Example 4 of this invention in a perspective view for explaining the attachment of a tubular body 43 and a brush bristle material 41. Referring to FIG. 4, the brush bristle material 41 that has been provided with a covering has one end part coated with adhesive agent 42 and fixed to the tubular body 43 made of synthetic resin.

### EXAMPLE 5

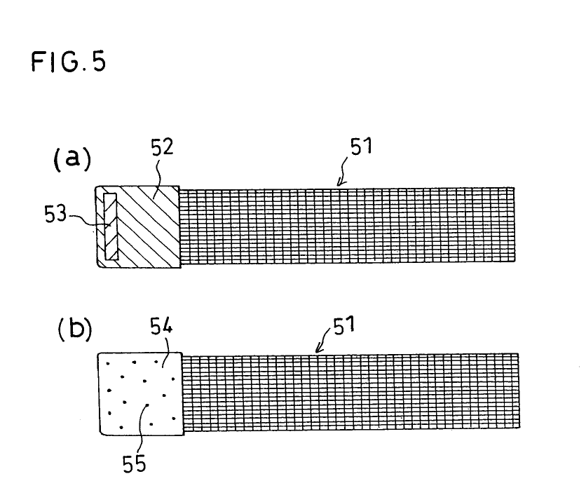

FIG. 5(a) and FIG. 5(b) severally depict Example 5 of this invention in a drawing for explaining a brush adapted to facilitate the attachment of a tubular body to a polishing device. The brush shown in FIG. 5(a) has a magnetic material 53, such as iron or an iron-based alloy, disposed in a tubular body 52 made of synthetic resin and adapted to fix one end part of a brush bristle material 51 that has undergone covering. The brush shown in FIG. 5(b) has grains of a magnetic material 55 contained in a mixed state in a tubular body 54 made of synthetic resin. The inclusion of the magnetic material 55 in the tubular body 54 made of synthetic resin is accomplished by causing the grains or powders of the magnetic material 55 to be included while the chips of synthetic resin are being heated and formed in the same manner as described above.

### EXAMPLE 6

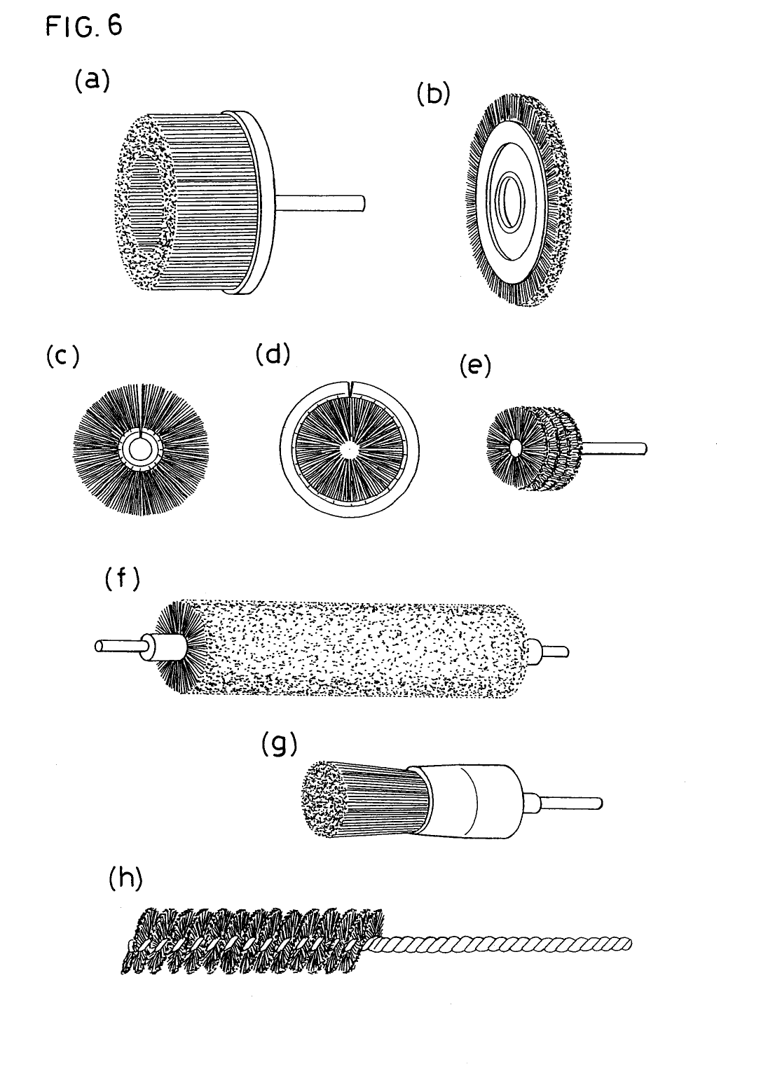

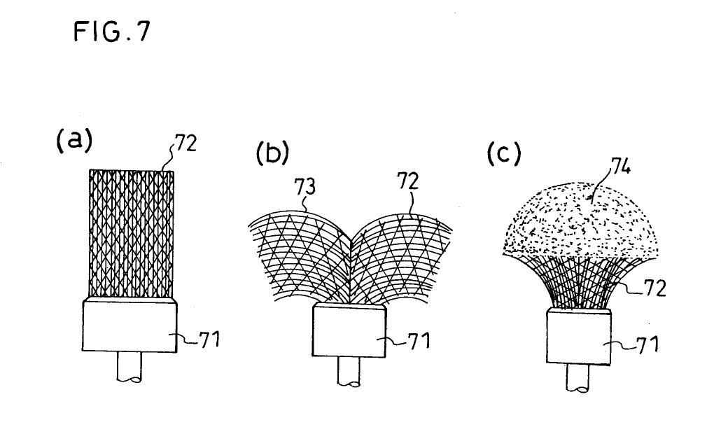

FIG. 6(a) to FIG. 6(h) are drawings for explaining the brushes manufactured from the brush bristle materials of this invention. FIG. 6(a) represents a cup brush, FIG. 6(b) a disc brush having a channel brush attached to the periphery of a disc, FIG. 6(c) a disc brush obtained by bending a channel in a circular shape, FIG. 6(d) a brush manufactured by directing toward the interior a brush bristle material attached to a channel, FIG. 6(e) and FIG. 6(f) each a roll brush, FIG. 6(g) a tubular brush and FIG. 6(h) a twisted brush. These brushes are manufactured from the brush bristle materials conforming to Examples of this invention.

This invention has been described specifically by reference to Examples. The invention nevertheless does not need to be limited to these Examples. This invention is capable of allowing various alterations of design unless the matters described in the scope of claim for patent are deviated. The raw material of brush bristle, the number of brush bristle materials, the quality of material of the substance to be included, the sizes, the shapes and the densities of the relevant materials can be optionally selected depending on the kind, the shape and the purpose of use of a given workpiece. Particularly as regards the metallic member, the synthetic resin member, the member to be included and the member to be attached, it goes without saying that those publicly known or universally known can be used besides those specifically cited in the present specification.

What is claimed is:

1. A brush bristle material comprising:
a brush bristle material having bundled a plurality of one or more kinds of brush bristles obtained by causing a synthetic resin material formed of single threads to contain in a mixed state one or more kinds of diamond abrasive grains or abrading grains;
a metallic fitting enabled to admit insertion of a proximal end part of the bundled brush bristle material and to fix the proximal end part; and
a covering containing abrasive grains in a mixed state and serving to cover the brush bristles from a part thereof excluding the proximal end part fixed by the metallic fitting to a distal end part thereof.

2. A brush bristle material comprising:
a brush bristle material having bundled a plurality of one or more kinds of brush bristles obtained by causing a perimeter of a metallic material formed of single threads to be clad with one or more kinds of diamond abrasive grains or abrading grains;
a metallic fitting enabled to admit insertion of a proximal end part of the bundled brush bristle material and to fix the proximal end part; and
a covering containing abrasive grains in a mixed state and serving to cover the brush bristles from a part thereof excluding the proximal end part fixed by the metallic fitting to a distal end part thereof.

3. A brush bristle material according to claim 1 or claim 2, wherein the covering is any material selected from among a string member, a network member, a plated member, a vapor-deposited member, a coating member, a pipe made of synthetic resin and a pipe made of metal which are invariably wound around a perimeter of the brush bristle material.

4. A brush bristle material according to claim 1 or claim 3, wherein the synthetic resin material contains in a mixed state one or more kinds of diamond abrasive grains, honing abrasive grains, charcoal, volcanic ash, negative ion material and flavor material at a ratio in a range of 1% to 50%.

5. A brush bristle material according to claim 2, wherein the metallic material has attached to a perimeter thereof one or more kinds of diamond abrasive grains and honing abrasive grains by electrodeposition, adhesive agent or plating treatment at a ratio in a range of 1% to 100%.

6. A brush bristle material according to any one of claim 1 to claim 5, wherein the brush bristle material comprises a plurality of brush bristle materials bundled into a bundle and the covering covers a perimeter of the bundle.

7. A brush bristle material according to any one of claim 1 to claim 6, wherein the brush bristle material comprises a plurality of different kinds of brush bristle materials bundled into a bundle and the covering covers a perimeter of the bundle.

8. A brush bristle material according to any one of claim 1 to claim 7, wherein the brush bristle material comprises a plurality of brush bristle materials bundled into a bundle and the covering covers a perimeter of the bundle.

9. A brush comprising the brush bristle material according to any one of claim 1 to claim 8 formed into a channel brush, an implanted brush or a welded brush and fated to serve as a roll brush, a wheel brush, a coiled brush, a tubular brush or a twisted brush.
